(19) United States
(12) Patent Application Publication
(10) Pub. No.: US 2018/0113802 A1
(43) Pub. Date: Apr. 26, 2018

(54) APPLICATION SIMULATOR FOR A VEHICLE

(71) Applicant: Sivakumar Yeddnapuddi, Van Buren Township, MI (US)

(72) Inventor: Sivakumar Yeddnapuddi, Van Buren Township, MI (US)

(21) Appl. No.: 15/791,162

(22) Filed: Oct. 23, 2017

Related U.S. Application Data
(60) Provisional application No. 62/411,323, filed on Oct. 21, 2016.

(51) Int. Cl. G06F 11/36; G06F 9/44; G06F 11/07; G06F 11/00

(52) U.S. Cl. CPC G06F 11/3692; G06F 8/10; G06F 11/008; G06F 11/0766; G06F 11/0751

(57) ABSTRACT

Disclosed herein are devices, methods and systems for implementing a vehicle-based simulator and an application store employing said vehicle-based simulator. Employing the aspects disclosed herein, an implementer of the various concepts may ensure a higher quality of vehicle installed applications.

### CROSS-REFERENCE TO RELATED APPLICATIONS

Priority is claimed to Provisional Application Ser. Nos. 62/411,323, filed Oct. 21, 2016; entitled MULTI-LEVEL OPERATING SYSTEM FOR A VEHICLE, now pending. This patent application contains the entire Detailed Description of U.S. Provisional Patent application No. 62/411,323.

### BACKGROUND

As electronics become more customize-able, users are provided with a whole host of third-party applications to install on their electronic devices. One such forum for said customization is the vehicle.

Vehicles are becoming more integrated with electronic modules that allow customization. Employing vehicular telematics or other methods of downloading data to said vehicles, the owner or operator of the vehicle is provided with the option of loading said electronic modules into their vehicle.

One such electronic module is the “app” (short for application). An app is defined as a software module that is download-able or installable in the vehicle. The apps may be provided in a repository, such as a downloadable cache of apps.

Third parties may upload apps that are created or provided by the third party. However, in doing so, the quality of said apps may not be known, and a user downloading said app may have their experience ultimately frustrated when said app is inoperable or operates with less than ideal quality/efficiency.

### SUMMARY

The following description relates to systems, methods, and applications for implementing a vehicle-based application simulator, and a vehicle-based application store. Exemplary embodiments may also be directed to any of the system, the method, or an application disclosed herein.

Additional features of the invention will be set forth in the description which follows, and in part will be apparent from the description, or may be learned by practice of the invention.

Disclosed herein are devices, methods and systems for implementing a vehicle-based simulator and an application store employing said vehicle-based simulator. Employing the aspects disclosed herein, an implementer of the various concepts may ensure a higher quality of vehicle installed applications.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTIONS OF THE DRAWINGS

The detailed description refers to the following drawings, in which like numerals refer to like items, and in which:

FIG. 1 illustrates an example of a flowchart illustrating a product design/testing/implementation lifeline according to the aspects disclosed herein;

FIG. 2 illustrates an exemplary system-level diagram according to the aspects disclosed herein;

FIGS. 3-5 illustrate various exemplary methods for implementing the system shown in FIG. 2;

FIG. 6 illustrates a graphical user interface of a vehicle-based application store according to the aspects disclosed herein.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

Disclosed herein are methods and system for ensuring application integrity. The systems and methods disclosed herein allow for apps that are not only crowd-sourced, but verified through a pre-vetting system.

Considering that there can be well over 900 different parameters (or more depending on the vehicle implementation), inter-connected and inter-dependent bundled into a vehicle, the hardware becomes the most important component while designing an app for a vehicle. That said the availability of hardware has always left the developer either waiting on a resource to be delivered or spending valuable time assembling it. While, hardware is an important criterion while designing apps for vehicles, it does not justify the increase in cost and time associated with the development of the app itself. The vehicle simulator aims to alleviate this commonly faced problem by providing the developer an interface where he can develop, test and deploy his app easily and efficiently.

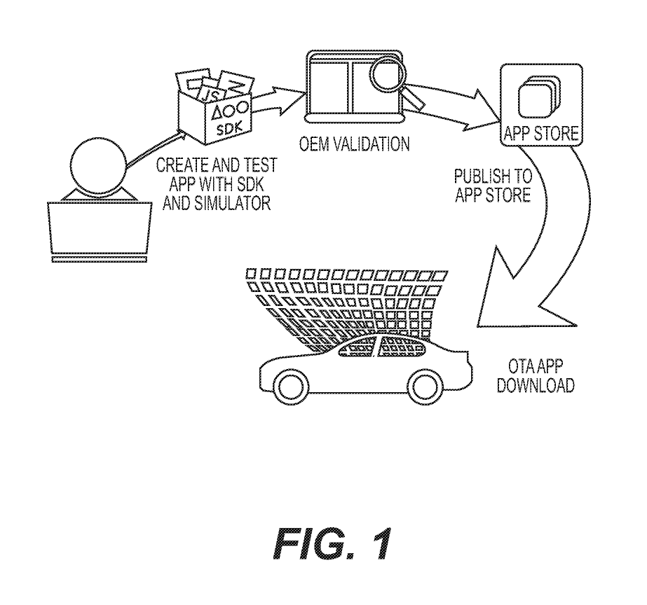

FIG. 1 illustrates a system according to an exemplary embodiment. Employing the system in FIG. 1, a third-party may upload an application to the system through any conventional techniques known for communicating over a network.

As shown, the system receives the app and processes it according to the aspects disclosed herein. The system is configured to simulate a vehicle and a vehicle's operation. As such, the app may be run and once tested, verified for whether the app works well with vehicles. For example, as shown the app may be tested to work with the following systems/conditions:

1) how the app works when the vehicle is in operation, and

2) how the app works with the provided software/hardware components.

For example, if an audio app is provided, it may be tested as to its performance when the vehicle undergoes certain changes causing an environmental impact to the context of how audio is perceived. For example, if the windows/doors are opened, a properly vetted audio app may be configured to raise in volume. As such, various stimuli associated with vehicular operation and use may be introduced in the testing/vetting process.

In another specific example (that may be employed for vetting an application), a driver of the vehicle may be enjoying the media app designed that plays mashups of songs based on the listening history. If the driver is so caught up with it this, he may not notice that a door hasn't closed properly.

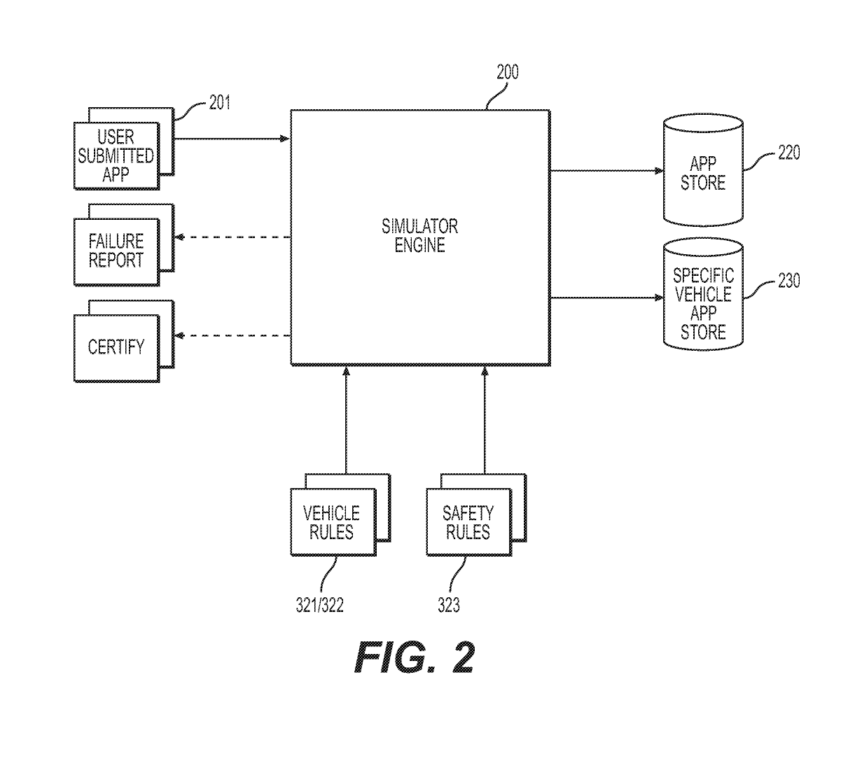

At this point, it becomes critical to obtain the driver's attention. Since, this is a system critical function, stopping the app and making the “Door Ajar” warning prominent on the display is of high priority. Employing the aspects disclosed herein, the systems shown in FIGS. 1 and 2 are configured to test and simulate for these conditions.

Additionally, the app may be vetted for how it works with various software and hardware components with all vehicles, a subset of vehicles, a specific vehicle.

Once the testing is complete, the app may be provided with an authentication credentials. Once provided with said authentication credentials, the app may be uploaded to an online repository to be publically or privately distributed to potential consumers.

In an alternative embodiment, the app is automatically transmitted to the online repository, and instantaneously made available to potential downloaders.

If the app fails, the uploading party may be provided with a report indicating why the app failed. As such, the third-party developer of said app may correct the problems causing the failure, and re-upload the app for an additional testing/simulation.

As such, employing the aspects disclosed herein and shown in the system in FIG. 1, a third-party developer of applications for a vehicular context is provided with a way to ensure that the applications work effectively when ultimately installed in the vehicular context. Additionally, the vehicle owner/passenger/occupant that uses the application is provided with apps that work effectively and are not inoperable or malicious.

The third-party developer may be provided with at least the following types of verification:

1) ensuring that system critical functionalities in a vehicle take priority over the application; and

2) ensuring that the interaction between the user input and the application is above a specific threshold.

A third-party developer is a provided a software development kit (SDK). The kit may be integrated with the simulators described herein. As noted, the simulations performed may vary, and be performed for a specific vehicle, a class of vehicles, or all vehicles. As such, a whole host of test data may be produced, with various thresholds associated with passing or vetting an app being configured by an implementer.

Once an app is tested, a data file associated with its test may be created. When a repository of applications receives said app, it may determine whether to accept the app, partially accept the app, or reject the app. A partial acceptance of the app is defined as allowing the application repository to determine whether the app may be distributed to a specific vehicle, or a class of vehicles.

FIG. 2 illustrates a system-level implementation of an application simulator for a vehicle-based application store employing the aspects disclosed herein.

Referring to FIG. 2, a third-party submitted application 201 is shown. As explained above, a third-party submitted application 201 may be any program downloaded or installed on a vehicle. The third-party submitted application 201 may be incorporated into the vehicle's operating system, and employed and executed in any of the vehicle's processing devices.

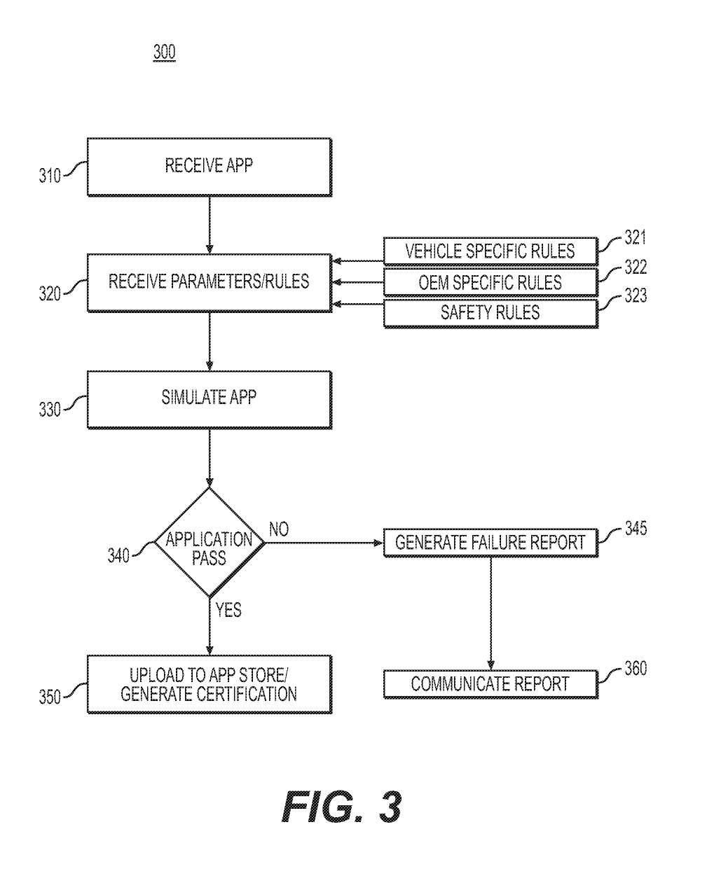

The third-party submitted application 201 is communicated to a simulator engine 200 (through wireless or wired communication techniques). For example a third-party developer may upload said third-party submitted application 201 to a server. After which, the application simulator engine 200 may perform actions based on the exemplary method 300 shown in FIG. 3.

In another example, the parameters may be associated with a threshold associated with quality. For example, if a parameter includes specific human-machine interface (HMI) instructions, the application 201 may be tested to determine if said application 201 is compliant with the HMI provide. For example, one of the vehicles being tested may have a head-up display (HUD). If the application 201 does not work with, or is compliant with HUD technology, the parameters may be employed by the application

The aspects disclosed above discuss providing metrics for the app that ensure safety. In another embodiment, the metrics may be directed towards usability thresholds.

As shown in FIG. 3, an application 201 may be received from a third-party in operation 310. As explained above, the application 201 may be received via any known communication mediums capable of transferring data from one source to another. For example a host of the application simulator 200 may store the application simulator 200 on a data storage device that is network connected. An interface or portal may be provided to accept an upload of the third-party submitted application 201.

In operation 320, the parameters associated with the simulation are either received and/or organized. The parameters may be sourced from additional sources, and be related to an individual vehicle (or group of vehicles) 321, a specific original equipment manufacturer 322, or general safety rules 323.

The parameters provide a listing of established applications and/or safety thresholds inherent with the associated set of vehicles/guidelines. For example, if the application 201 to be tested generates a noise, the parameters may determine whether the application 201 executes while a safety-critical noise application is being generated.

As shown, general safety parameters 323 may also be provided. For example, if the application 201 overrides or disables an alert associated with an ADAS or safety-critical application, application simulator 200, employing general safety parameters 323 may test for this condition.

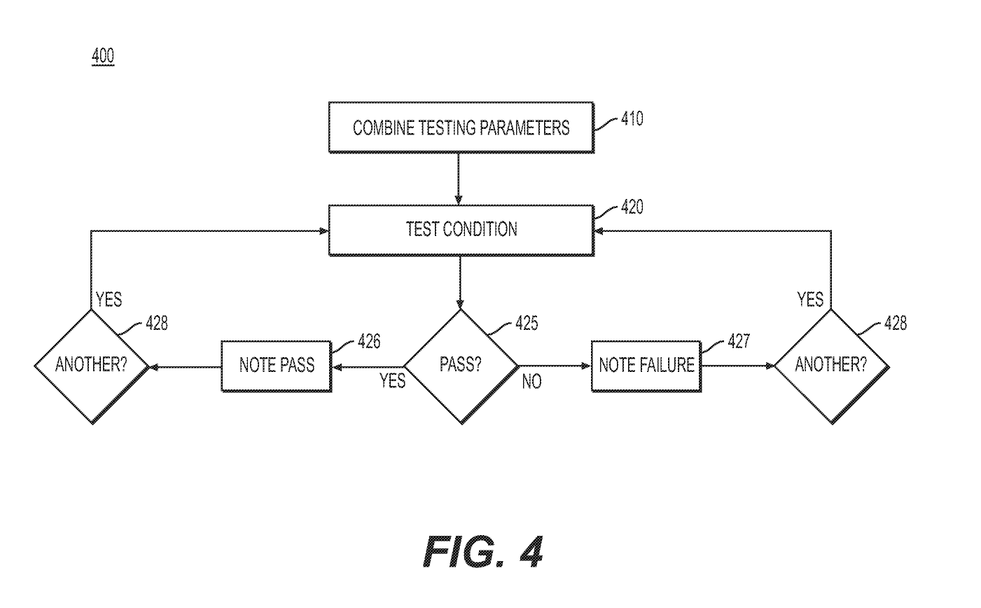

In operation 330, the application 201 is simulated or tested with either all or some of the parameters listed above (vehicle-specific 321, OEM specific 322, or general rules 323). FIG. 4 illustrates an exemplary method 400 associated with testing an application 201 according to the aspects disclosed herein.

As shown in FIG. 4, in operation 410, a collection of tested for conditions are generated from the selected parameters discussed above. The tested for conditions may establish a collection of vehicle-based safety systems, established applications, vehicle-based HMI devices, sensors, vehicle-components, vehicle-based operating systems and other tested for conditions associated with the vehicle.

Once the tested for conditions are established, in operations 420-428, each individual tested for condition is tested. In operation 420, a tested for condition is selected (from the established list in operation 410), and tested in operation 425. The application simulator 200 is configured to simulate a real-time operation of the vehicle (or group of vehicles) associated with.

If the tested for condition passes, a notation of pass is recorded in a data file 426. Conversely, if the test for condition fails, a notation of failure is recorded in the same data file (427). After each notation, an iterative determination is made to determine whether there is another tested-for condition established in operation 410. If there is, the process described above operates in an iterative manner until all tested-for conditions are met.

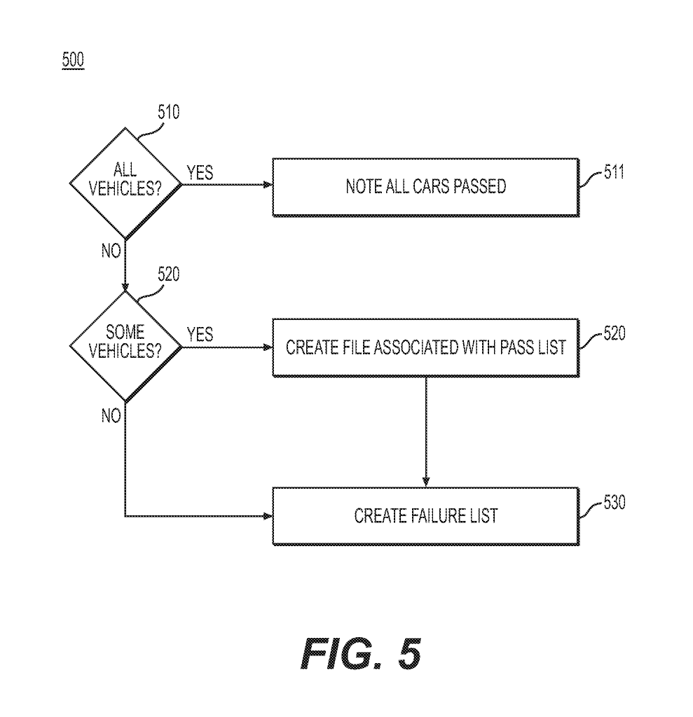

After the application simulator 200 executes, and the data file generated in association with method 400 is created, the determination in operation 340 may be performed. FIG. 5 illustrates a method 500 for performing the determination 340 according to the aspects disclosed herein.

In operation 510, a determination is made as to whether the third-party application 201 passed for all vehicles. If yes, a notation is made as to the third-party application 201 passing for all vehicles (511).

As shown in FIG. 2, a certification 203 may be transmitted to the source of the third-party application 201 (for example the developer). This certification 203 may be transmitted, along with the third-party application 201, to an application store 220.

Alternatively, the third-party application 201 may be automatically submitted to the application store 220. After which, the third-party application 201 may be downloadable (or available for purchase) from potential users/consumers accessing the application store 220.

In response to the third-party application 201 not passing for all vehicles, a determination is made as to whether the third-party application 201 passes for some vehicles (or a specific set of vehicles, e.g. sourced from a single OEM). The grouping of vehicles may be selected by an implementer of the system 200. For example, the grouping may include vehicles with specific components, HMI devices, operating systems, or a combination thereof

In response to the third-party application 201 passing for a subset of vehicles, a notification is recorded in operation 521. As similarly performed in operation 511, the notification may be returned to the third-party application 201 developer via a certification (indicating which vehicle, vehicles, or subset of vehicles the application is compliant with). Alternatively, the third-party application 201 may be uploaded to either the application store 220 with the certification indicating the compliant set of vehicles, or alternatively, to a vehicle (or subset of vehicle) specific application store 230.

In operation 530, a failure notification (202) is created, and transmitted back to the third-party application 201 developer. This notification may also be created after operation 520/521. As such, a developer may be cognizant of the issues causing the third-party application 201 to fail.

Referring to method 300, as shown with regards to operation 340 and explained via method 500, after the determination, the system 200 may generate a failure report 345 (and communicate said failure report 360), upload the third-party application 201 to an app store (220 or 230) and/or generate a certification indicating the same, or perform a combination of both.

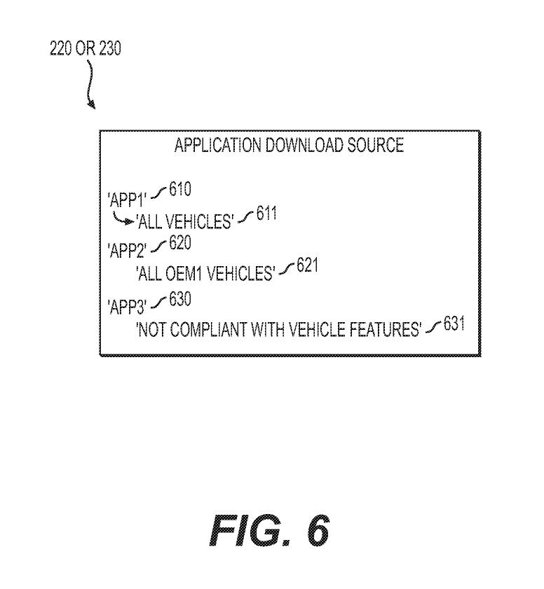

FIG. 6 illustrates an example display screen implementing the aspects disclosed herein. The display screen may be associated with an app store catering to applications associated with vehicle-based applications.

Referring to FIG. 6, a ‘APP 1’ 610. In addition to showing the application, a label 611 is provided indicating that said first ‘APP 1’ 610 works with or is certified for all vehicles. As such, the user is cognizant of this, and may download the application with this knowledge. Alternatively, the implementer of the application store may permit or not permit downloads contingent on this certification.

Following the listed applications, the next application shown in ‘APP 2’ 610. This application is shown to work with or is certified with a subset of vehicles associated with an ‘OEM 1’ (as indicated by label 621).

Finally, at the bottom of the screen shown in FIG. 6, is ‘APP 3’ 630. This application is not compliant with vehicles of specific feature, as indicated by label 631. For example, this application may not work with vehicles implementing a HUD, or with a specific connectivity (or lack thereof). Thus, a user is notified that the application is not compliant with a specific vehicle-based component, other applications, vehicle-based sensors, or an operating system, or a combination thereof.

Thus, employing the aspects disclosed herein, application developers may not only develop applications for the vehicle-based environment, but also ensure that said applications are vetted for all, some, or a subset of vehicles. Accordingly, vehicles employing computer-based third party applications may ensure a higher quality of working and safe applications.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

We claim:

1. A system for simulating an application for vehicle usage, comprising:
a data store comprising a non-transitory computer readable medium storing a program of instructions for the providing;
a processor that executes the program of instructions, the instruction comprising the following steps:
receiving an application from a source;
receiving parameters for simulating said application, said parameters being defined as vehicle-based rules;
simulating the application based on the received parameters, and
generating a report based on the simulation.

2. The system according to claim 1, wherein the parameters are defined as rules associated with safety for a specific vehicle.

3. The system according to claim 1, wherein the parameters are defined by rules associated with safety for a subset of vehicles.

4. The system according to claim 1, wherein the application is simulated to determine whether the application overrides a safety-based audio/visual cue associated with a vehicle-based ADAS component.

5. The system according to claim 1, wherein the report indicates that the simulation failed partially.

6. The system according to claim 1, wherein the report is a certification, and is employed to allow uploading to a vehicle-based application store.

7. The system according to claim 6, wherein the certification is employed to determine whether the application associated with said certification is downloadable to a specific vehicle.

8. The system according to claim 6, wherein the certification is employed to determine whether the application associated with said certification is downloadable to a specific class of vehicles.

9. The system according to claim 1, wherein the simulation is configured to determine whether the application is compliant with a specific vehicle-based component.

10. A system for implementing a vehicle-based application store, comprising:
a data store comprising a non-transitory computer readable medium storing a program of instructions for the providing;
a processor that executes the program of instructions, the instruction comprising the following steps:
storing a plurality of applications for download via a vehicle-based computing system; and
associating each of the plurality of applications with a unique certification associated with the respective one of the plurality of applications

11. The system according to claim 10, wherein the certification defines a specific vehicle, in which the certification indicates whether the associated one of the plurality of applications is compliant with the specific vehicle.

12. The system according to claim 10, wherein the certification defines a specific group of vehicles, in which the certification indicates whether the associated one of the plurality of applications is compliant with the specific group of vehicles.

13. The system according to claim 10, wherein the certification defines a vehicle-based component, in which the certification indicates whether the associated one of the plurality of applications is compliant with the vehicle-based component.
